(19) United States
(12) Patent Application Publication
(10) Pub. No.: US 2016/0275862 A1
(43) Pub. Date: Sep. 22, 2016

(54) ADDRESSING OF GROUPS OF TRANSISTORS IN A MATRIX ARRANGEMENT

(71) Applicant: FLEXENABLE LIMITED, Cambridge (GB)

(72) Inventors: Stephan RIEDEL, Dresden (DE); Jeremy HILLS, Cambridge (GB); James HARDING, Cambridge (GB)

(73) Assignee: FLEXENABLE LIMITED, Cambridge (GB)

(21) Appl. No.: 15/026,802

(22) PCT Filed: Oct. 7, 2014
(86) PCT No.: PCT/EP2014/071447

§ 371 Date: Apr. 1, 2016

(30) Foreign Application Priority Data
Oct. 8, 2013 (GB) 1317764.7

(51) Int. Cl. G09G 3/3258

(52) U.S. Cl. CPC G09G 3/3258; G09G 2300/0426; G09G 2310/08

(57) ABSTRACT

A device comprising an array of transistors; wherein the device comprises an array of first conductors providing either the gate electrodes or the source electrodes for the transistors, and an array of second conductors providing the other of the gate electrodes and the source electrodes for the transistors; wherein the first conductors include conductors that are each associated with a respective group of N rows of the array of transistors; and wherein the columns of transistors include columns of transistors that are associated with a respective set of N second conductors of the array of second conductors, and each second conductor in each set of N second conductors is associated with a respective set of 1/N transistors in the respective column of transistors; wherein N is greater than 1.

The addressing operation of a transistor array involves independently controlling the electric potential at the drain electrode of each transistor of the array.

One addressing technique involves sequentially switching rows of transistors between off and on states by controlling the voltage at the gate electrodes of the rows of transistors, and then applying a respective data voltage to the source electrode of each transistor in the row of transistors that is in the on state. One or more conductor layers define an array of gate conductors and an array of source conductors, each gate conductor providing the gate electrodes for a respective row of transistors of the transistor array and connected to a respective terminal output of a gate driver, and each source conductor providing the source electrodes for a respective column of transistors of the transistor array and connected to a respective terminal output of a source driver.

The inventors for the present application have identified the challenge of developing a new technique for addressing transistors in a transistor array.

There is hereby provided a device comprising an array of transistors; wherein the device comprises an array of first conductors providing either the gate electrodes or the source electrodes for the transistors, and an array of second conductors providing the other of the gate electrodes and the source electrodes for the transistors; wherein the first conductors include conductors that are each associated with a respective group of N rows of the array of transistors; and wherein the columns of transistors include columns of transistors that are associated with a respective set of N second conductors of the array of second conductors, and each second conductor in each set of N second conductors is associated with a respective set of 1/N transistors in the respective column of transistors; wherein N is greater than 1.

According to one embodiment, N is an integer greater than 1.

According to one embodiment, the first conductors provide the gate electrodes for the transistors and the second conductors provide source electrodes for the transistors.

According to one embodiment, the first conductors provide source electrodes for the transistors and the second conductors provide gate electrodes for the transistors.

According to one embodiment N is 2.

According to one embodiment, the device further comprises one or more drivers;

wherein each of the first and second conductors is connected to a respective output terminal of the one or more driver chips.

According to one embodiment, at least the first conductors are routed around at least one corner of the array of transistors.

According to one embodiment, the device further comprises an array of pixel conductors, wherein each row of pixel conductors is associated with a respective row of transistors and each column of pixel conductors is associated with a respective column of transistors.

According to one embodiment, the device further comprises an optical media whose optical state changes in response to a change in electrical potential at one or more of the pixel conductors.

According to one embodiment, the device comprises an array of pixel electrodes each associated with a respective one of said array of transistors, and each row of transistors comprises the transistors for a respective row of pixel electrodes, and each column of transistors comprises the transistors for a respective column of pixel electrodes.

An embodiment of the present invention is described in detail hereunder, by way of non-limiting example only, with reference to the accompanying drawings, in which:

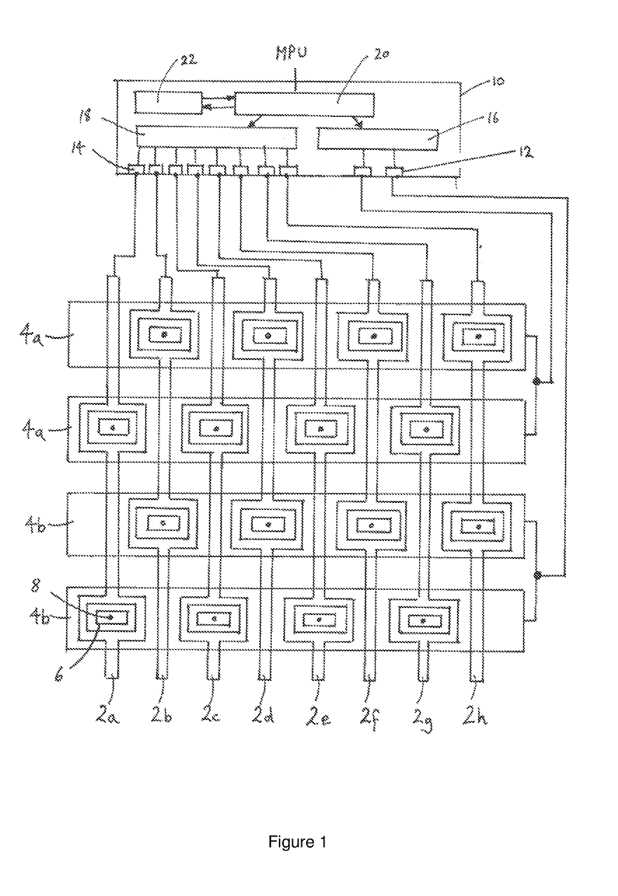

FIG. 1 is a schematic plan view of an example of a configuration of the source, drain and gate conductors of a transistor array;

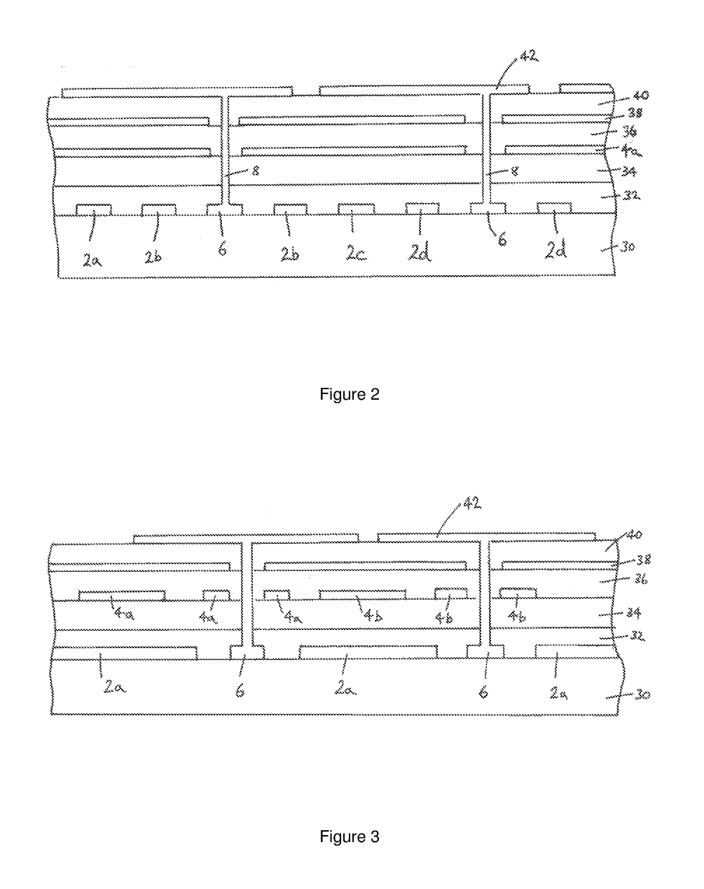

FIGS. 2 and 3 are schematic cross-sectional views of parts of the example configuration illustrated in FIG. 1;

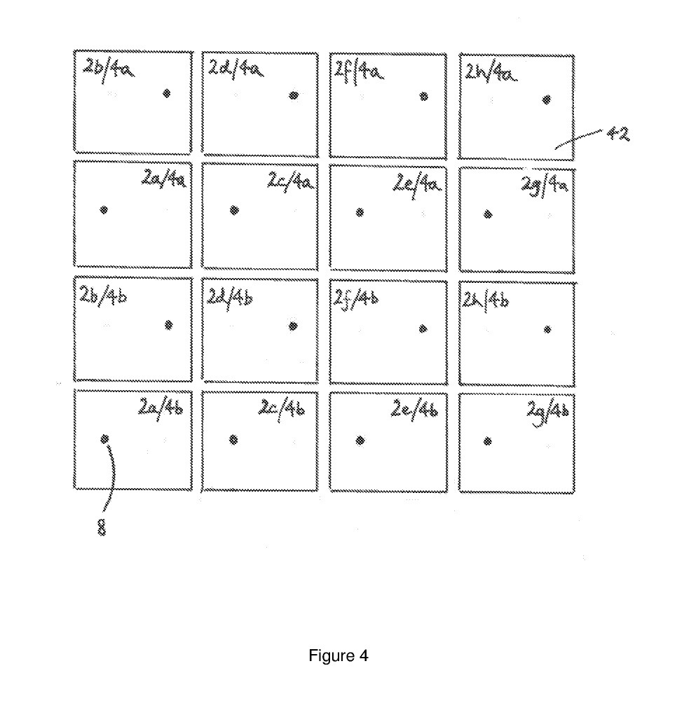

FIG. 4 is a schematic plan view of an example of an arrangement for the pixel conductors shown in FIGS. 2 and 3;

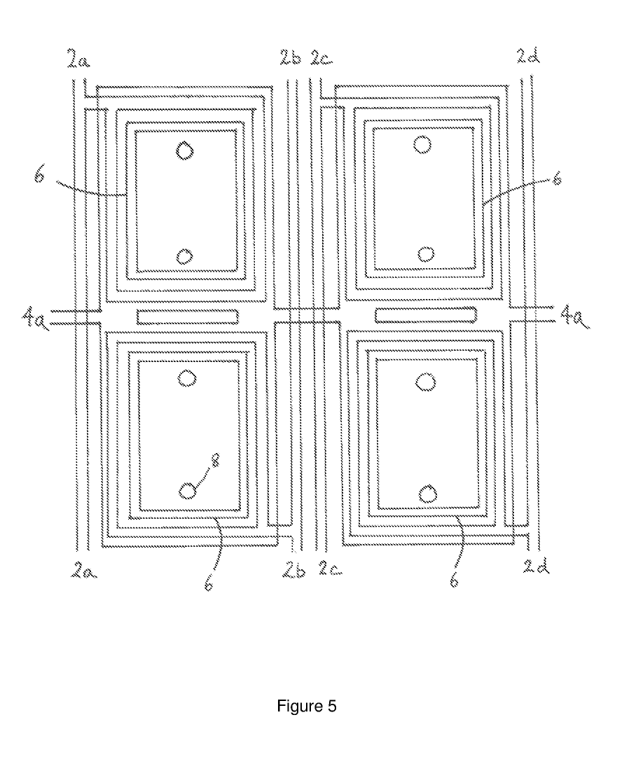

FIG. 5 illustrates another example of a configuration for the source, drain and gate conductors in FIG. 1;

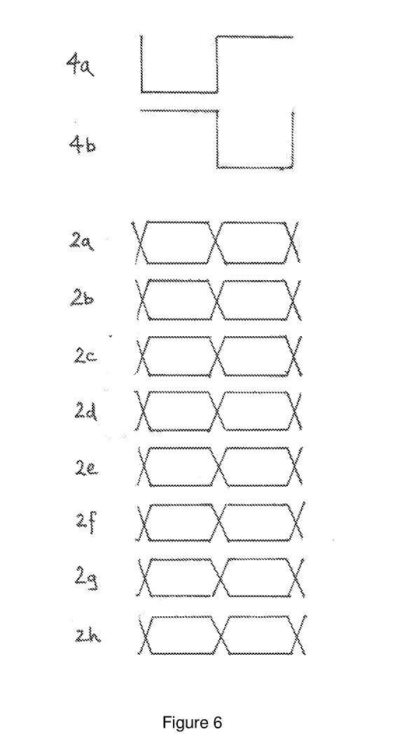

FIG. 6 illustrates an example of the timing of signals applied to the gate and source conductors in FIG. 1 or FIG. 5;

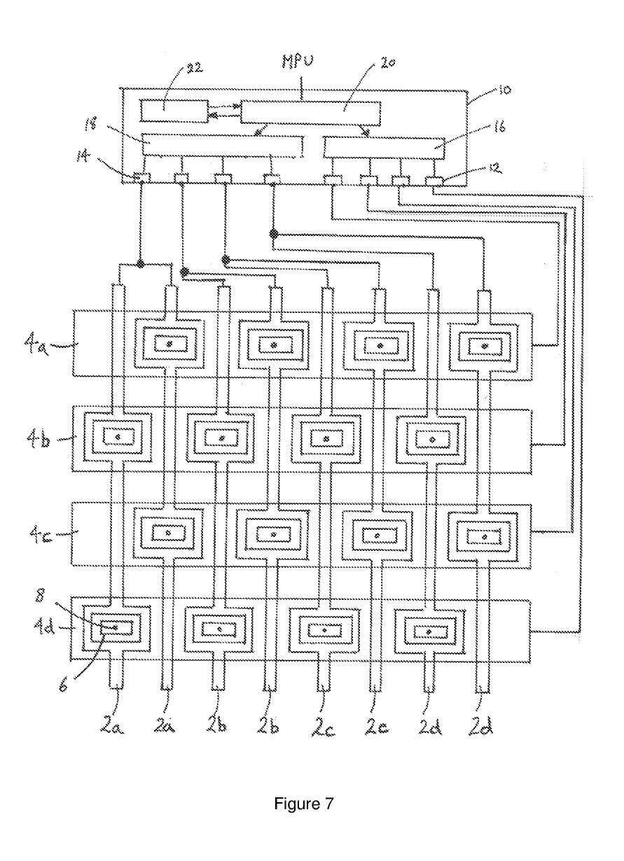

FIG. 7 is a schematic plan view of another example of a configuration of the source, drain and gate conductors of a transistor array;

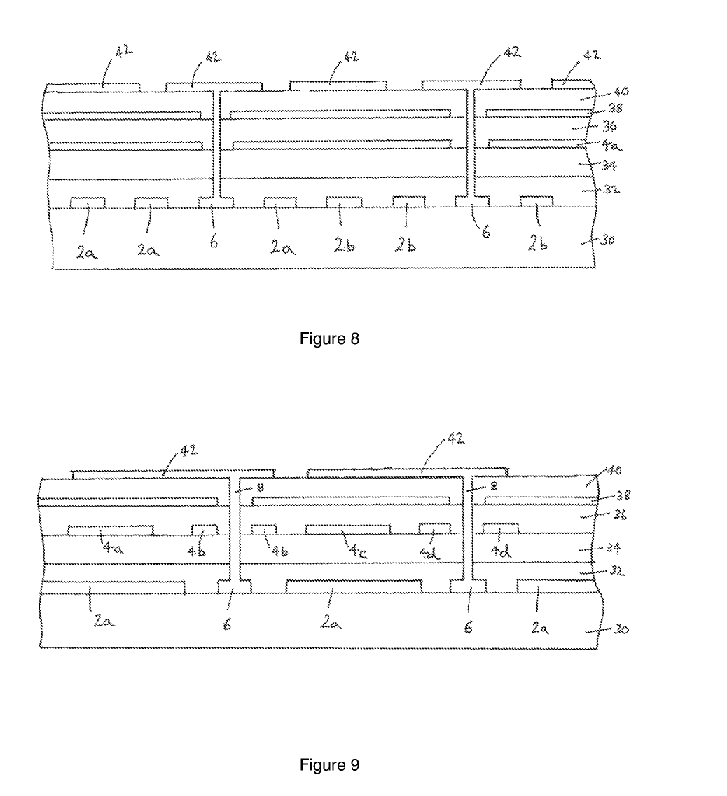

FIGS. 8 and 9 are schematic cross-sectional views of parts of the example configuration illustrated in FIG. 7;

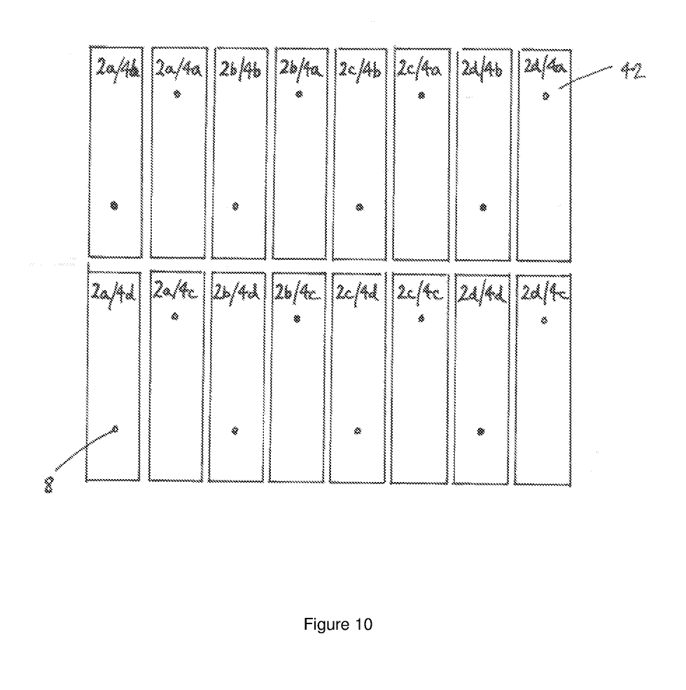

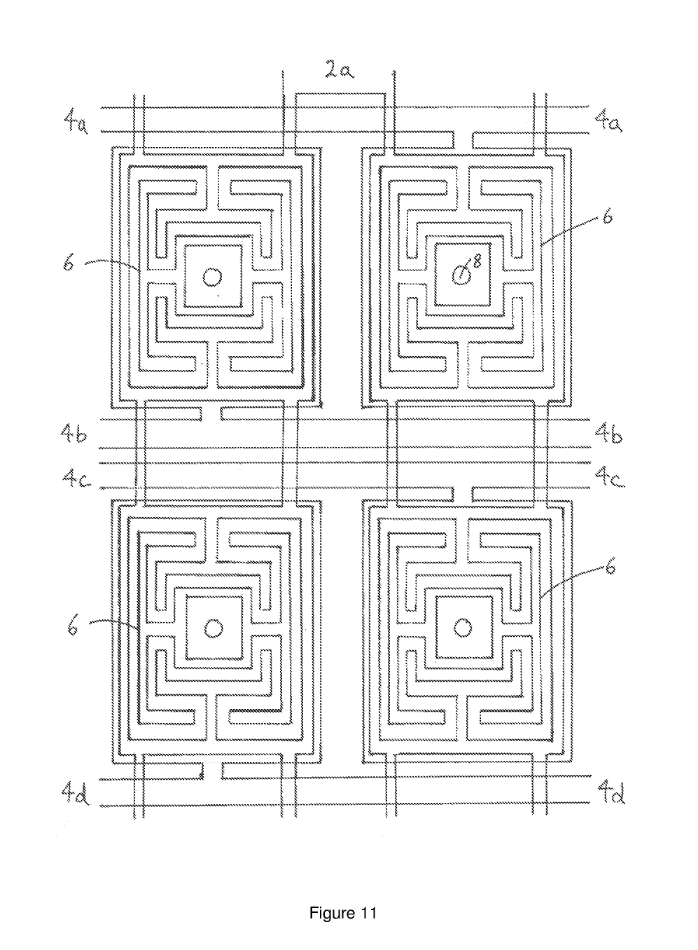

FIG. 10 is a schematic plan view of an example of an arrangement for the pixel conductors shown in FIGS. 7 and 8;

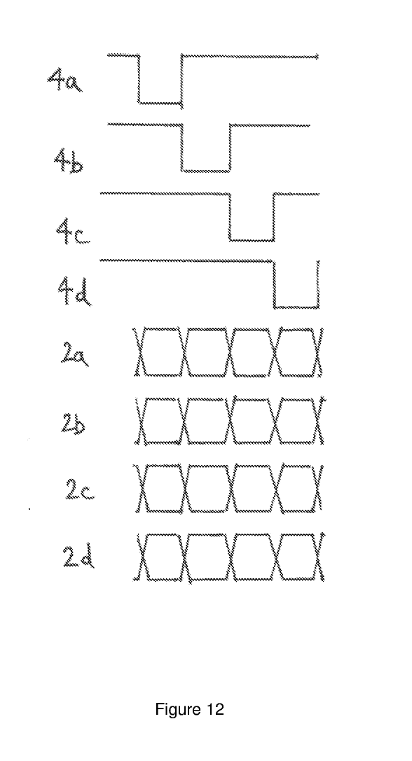

FIG. 11 illustrates another example of a configuration for the source, drain and gate conductors in FIG. 7;

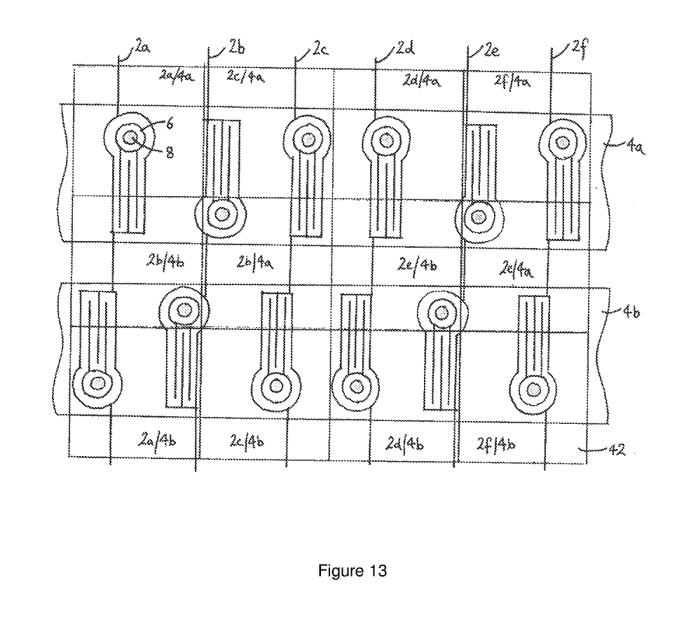

FIG. 12 illustrates an example of the timing of signals applied to the gate and source conductors in FIG. 7 and FIG. 11; and

FIG. 13 is a schematic plan view of another example of a configuration for the source, drain and gate conductors of a transistor array.

For the sake of simplicity, examples of techniques according to an embodiment of the present invention are described for the example of small arrays of sixteen thin film transistors (TFTs); but the same type of configuration is applicable to much larger transistor arrays such as transistor arrays comprising more than a million transistors. Other examples of ways in which the devices illustrated in the drawings can be modified within the scope of the present invention, are discussed at the end of this description.

In the following description, the terms “row” and “column” mean series of transistors/pixels extending in substantially orthogonal directions.

A first example of a technique is illustrated in FIGS. 1 to 4 for a 4×4 array of transistors. FIG. 1 is a schematic plan view showing an example of the configuration of the source and gate conductors; FIGS. 2 and 3 are schematic cross-sectional views along parts of the gate and source conductors of FIG. 1; and FIG. 4 is a schematic plan view showing an example for an arrangement of the pixel conductors.

A first patterned conductor layer is provided on a supporting substrate 30. The supporting substrate 30 may, for example, comprise a plastic film and a planarisation layer formed between the plastic film and the first conductor layer, and one or more additional, functional layers (e.g. conductor and/or insulator layers) either between the plastic film and the planarisation layer, and/or between the planarisation layer and the first patterned conductor layer, and/or on the opposite side of the plastic film to the planarisation layer.

The first patterned conductor layer is patterned to define (i) an array of source conductors 2a-2h, and (ii) an array of drain conductors 6 which each provide the drain electrode for a respective transistor. In this example, each column of the four columns of transistors is served by a respective pair of source conductors 2a/2b, 2c/2d, 2e/2f, 2g/2h, and each source conductor of each pair of source conductors provides the source electrodes for a respective half of the transistors in that column. In this example, the pair of source conductors provide source electrodes for alternate transistors in the respective column of transistors. This patterning of the first patterned conductor layer may, for example, be achieved by a photolithographic technique. Each source conductor 2 is connected to a respective output terminal 14 of a source driver.

Over the patterned first conductor layer defining the source and drain conductors 2, 6 is formed a semiconductor layer 32, which provides a respective semiconductor channel for each transistor. The semiconductor layer 32 may, for example, be an organic polymer semiconductor deposited by a liquid processing technique such as spin-coating or flexographic printing.

Over the semiconductor layer 32 is formed a dielectric layer 34, which provides a respective gate dielectric for each transistor. The dielectric layer may, for example, comprise one or more organic polymer dielectric layers.

Over the dielectric layer 34 and semiconductor layer 32 is deposited a conductor material which forms a second conductor layer extending over the dielectric layer 34.

The second conductor layer is then patterned to define (i) an array of gate conductors 4a and 4b. In this example, each gate conductor provides the gate electrodes for a respective pair of transistor rows. In this example, the gate conductors 4a, 4b are routed around one corner of the transistor array to respective gate output terminals of a gate/source driver chip 10.

The patterning of the second conductor layer also defines through holes in the gate conductors 4 at locations over the centres of the drain conductors 6. As discussed below, these through holes allow the formation of interlayer conductive connections 8 between the drain conductors 6 and respective top pixel conductors 42.

Over the second patterned conductor layer is formed an insulator layer 36, and over the insulator layer 36 is formed a third conductor layer 38. The third conductor layer 38 is patterned to define a substantially continuous conductor layer punctured by through holes that allow the formation of interlayer conductive connections 10 between the drain conductors 6 through the second and third conductor layers and up to respective top pixel conductors 42. This third conductor layer functions to screen the top pixel conductors 42 from the effects of electric potentials at all underlying conductors, including the gate conductors 4.

Over the third conductor layer is formed a further insulator layer 40. The insulator layers 36, 40 may, for example, be organic polymer insulator layers. The insulator layers 36, 40, dielectric layer 34 and semiconductor layer 32 are then patterned to define through holes extending down to each drain conductor 6 via the through holes defined in the third conductor layer and via the through holes defined in the gate conductors 4. These through holes have a diameter smaller than the through holes defined in the gate conductors 4 and the third conductor layer in order to avoid any electrical shorts between the interlayer conductive connections 8 and the third conductor layer 38 and/or gate conductors 4.

Over the top insulator layer 40 is deposited a conductor material. The conductor material fills the through holes defined in the insulator layers 36, 40, dielectric layer 34 and semiconductor layer 32 and forms a fourth conductor layer 42 over the top insulator layer 40. This fourth conductor layer is then patterned to form an array of pixel conductors 42, each pixel conductor associated with a respective drain conductor 6. The pixel conductors 42 may, for example, be used to control an optical media (not shown) provided above the fourth conductor layer. As indicated in FIG. 4, each pixel conductor 42 is connected to a respective drain electrode, and is therefore associated with a respective unique combination of source and gate conductors. Each gate conductor is associated with a respective pair of pixel rows; and each column of pixels is served by a respective pair of source conductors associated with alternating pixels in the column.

In the example illustrated in FIG. 1, each gate conductor takes the form of two parallel component conductors within the area of the transistor array. According to one variation example, each gate conductor may also take the form of a solid gate conductor line within the area of the transistor array.

FIG. 1 illustrates an example of a configuration for the source, drain and gate conductors in which the drain conductors for a column of pixels are arranged in a staggered fashion on alternating sides of a centre line parallel to the column of pixels; and each gate conductor takes the form of two parallel component conductors connected at an edge of the transistor array. One variation example is illustrated in FIG. 5, in which the centres of the drain conductors for a column of pixels all lie on a single imaginary straight line; and each gate conductor has a branched form within the area of the transistor array, each branch extending over the semiconductor channel of a respective transistor.

Examples of materials for the first, second, third and fourth conductor layers include metals and metal alloys.

In this example, a combined gate/source driver chip 10 is bonded to the substrate 30 at an edge of the transistor array. The single chip driver integrated circuit (IC) 10 comprises a gate driver block 16, a source driver block 18, a logic block 20 and a memory block 22. The functions of the logic block 22 include: interfacing between the driver IC 10 and a main processing unit (MPU); transferring data to and from the memory 22; co-ordinating the signals applied by the gate and source driver blocks to the gate and source output terminals 12, 14; and controlling the transfer of output data to the source driver block 20. The driver IC 10 may include other blocks.

The driver chip 10 operates to (i) sequentially switch pairs of transistor rows between off and on states by applying appropriate voltages to the respective gate conductors 4, and (ii) simultaneously apply respective data voltages to all of the source conductors 2 to achieve the desired respective electric potentials at each pixel conductor 42 associated with the pair of transistor rows in the on-state. FIG. 6 illustrates an example of the timing of signals applied to the gate and source conductors for this first example.

In this first example, this configuration of source and gate conductors makes it possible to operate a 4×4 TFT array using a chip that can also be used for a 2×8 TFT array. Another advantage of the kind of example configuration illustrated in FIG. 1 is that it requires less routing of the source/gate conductors around the periphery of the transistor array, compared to the case where a 4×4 array is driven by a chip having four source output terminals and four gate output terminals.

A second example of a configuration for the source and drain conductors is shown in FIGS. 7 to 10. FIG. 7 is a schematic plan view showing the second example of the configuration of the source and gate conductors; FIGS. 8 and 9 are schematic cross-sectional views along parts of the gate and source conductors in FIG. 7; and FIG. 10 is a schematic plan view showing an example of an arrangement for the pixel conductors.

This second example is substantially the same as the first example except that: (a) the second example includes four source conductors instead of eight source conductors, each of the four source conductors providing the source electrodes for a respective pair of columns in a 8×2 transistor array and connected to a respective output terminal of the source driver; and (b) the second example includes four gate conductors instead of two gate conductors, wherein each row of the two transistor rows of the 8×2 array are provided by a respective pair of gate conductors, the pair of gate conductors providing gate electrodes for alternating transistors in the respective row.

In this second example, the driver chip 10 operates to: (i) sequentially switch portions of transistor rows between off and on states by applying appropriate voltages to the respective gate conductor 4, and (ii) simultaneously apply respective data voltages to all of the source conductors 2 to achieve the desired respective electric potentials at each pixel conductor associated with the transistor row portion in the on-state. FIG. 12 illustrates an example of the timing of signals applied to the gate and source conductors.

As indicated in FIG. 10, each pixel conductor 42 is connected to a respective drain conductor 6, and is therefore associated with a respective unique combination of source and gate conductors. The example of FIG. 10 includes an array of rectangular pixel conductors, but the pixel conductors may have other shapes such as square conductors. Each source conductor is associated with a respective pair of pixel columns; and each row of pixels is served by a respective pair of gate conductors, each of the pair of gate conductors associated with alternate pixels in the row. In this second example, the configuration of source and gate conductors makes it possible to operate a 8×2 TFT array using a chip that can also be used for a 4×4 TFT array. More generally, this kind of technique can make it possible to operate a TFT array having a relatively unconventional aspect ratio (e.g. 16:3) using a chip or chip set that can also be used to operate a TFT having a more conventional aspect ratio (e.g. 4:3).

FIG. 7 illustrates an example of a configuration for the source, drain and gate conductors in which the drain conductors for a row of pixels are arranged in a staggered fashion on alternating sides of an imaginary centre line parallel to the row of pixels; and each gate conductor takes the form within the area of the transistor array of two parallel component conductors joined together at an edge of the transistor array. One variation example is illustrated in FIG. 11, in which the centres of the drain conductors for a row of pixels all lie on an imaginary straight line; and each gate conductor has a branched form within the area of the transistor array, the branches of a gate conductor extending over the semiconductor channels of every other transistor in the set of transistors for the respective row of pixels. In the variation example of FIG. 11, the source and drain conductors have an interdigitated configuration.

The description above relates to the example of an array of top-gate transistors. The above-described technique is equally applicable to arrays of bottom-gate transistors, in which case the deposition order of the first patterned conductor layer, semiconductor layer 32, dielectric layer 34 and second patterned conductor layer would be reversed, and no through holes would need to be defined in the gate conductors 4.

A third example of a configuration for the source and drain conductors is shown in FIG. 13.

This third example is substantially the same as the first example except that eight source conductors and 2 gate conductors are used to control the TFTs for a 4×3 pixel array. In FIG. 13, the square grid indicates the location of the pixel electrodes 42 of the 4×3 pixel array. Each pixel electrode 42 is connected to the drain conductor 6 of a respective one of the 12 TFTs via respective interlayer connection 8. Although not shown in FIG. 13, the pixel electrodes 42 are all conductively isolated from each other within the patterned conductor layer defining the array of pixel electrodes 42. One gate conductor 4a provides the gate electrodes for all the TFTs in a first pixel row and half the TFTs in a second pixel row; and the other gate conductor 4b provides the gate electrodes for the remaining half of the TFTs in the second pixel and all the TFTs in a third pixel row. Similarly, each column of pixels is associated with a source conductor exclusive to that column and a source conductor that it shares with an adjacent column of transistors. In other words, each gate conductors provides the gate electrodes for the TFTs for 1.5 pixel rows, and each set of three source conductors is associated with the TFTs for a respective set of two pixel columns.

Each source conductor is connected to a respective terminal of a source driver chip, and each gate conductor is connected to a respective terminal of a gate driver chip. In this third example, the driver chips operate to: (i) sequentially switch portions of transistor rows between off and on states by applying appropriate voltages to the respective gate conductor 4, and (ii) simultaneously apply respective data voltages to all of the source conductors 2 to achieve the desired respective electric potentials at each pixel conductor associated with the transistor row portion in the on-state. FIG. 13 also indicates the respective combination of source and gate conductors for each pixel.

In this third example, the configuration of source and gate conductors makes it possible to operate a 4×3 TFT array using a chip that can also be used for a 8×2 TFT array.

In all the examples described above involving an array of pixel conductors controlled by the transistors, rows and columns of transistors refer to the rows and columns of the pixel conductors 42 with which they are associated, and not necessarily to the pattern of the transistor array itself.

The description above relates to the example of an annular semiconductor channel design in which the drain electrode for each transistor is encompassed within the source-drain conductor layer by the source electrode for that transistor. The above-described technique is equally applicable to other semiconductor channel designs, including non-annular semiconductor channel designs and other kinds of annular semiconductor channel designs. For example, the source and drain electrodes for each transistor may comprise interdigitated finger structures.

The above-description relates to the example of providing a single driver chip for both the gate and source conductors, but the above-described technique is also applicable to, for example, devices in which separate driver chips are provided for the driving the source and gate conductors.

The above-description relates to the examples where N=2 and N=3/2, but N may be greater than 2.

The above description relates to an example in which the gate and source conductors occupy different levels within the footprint of the TFT array, and either the source or gate conductors are routed around one corner of the TFT array. However, the above-described technique can also be used in combination with a technique in which the gate conductors or source conductors are routed to the driver chip(s) via locations between the other of the gate and source conductors at the same level as the other of the gate and source conductors within the footprint of the array.

In addition to the modifications explicitly mentioned above, it will be evident to a person skilled in the art that various other modifications of the described embodiment may be made within the scope of the invention.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A device comprising an array of transistors; wherein the device comprises an array of first conductors providing either the gate electrodes or the source electrodes for the transistors, and an array of second conductors providing the other of the gate electrodes and the source electrodes for the transistors; wherein the first conductors include conductors that are each associated with a respective group of N rows of the array of transistors; and wherein the columns of transistors include columns of transistors that are associated with a respective set of N second conductors of the array of second conductors, and each second conductor in each set of N second conductors is associated with a respective set of 1/N transistors in the respective column of transistors; wherein N is greater than 1.

2. The device according to claim 1, wherein N is an integer greater than 1.

3. The device according to claim 1, wherein the first conductors provide the gate electrodes for the transistors and the second conductors provide source electrodes for the transistors.

4. The device according to claim 1, wherein the first conductors provide source electrodes for the transistors and the second conductors provide gate electrodes for the transistors.

5. The device according to claim 2, wherein N is 2.

6. The device according to claim 1, further comprising one or more drivers; wherein each of the first and second conductor is connected to a respective output terminal of the one or more driver chips.

7. The device according to claim 1, wherein at least the first conductors are routed around at least one corner of the array of transistors.

8. The device according to claim 1, further comprising an array of pixel conductors, wherein each row of pixel conductors is associated with a respective row of transistors and each column of pixel conductors is associated with a respective column of transistors.

9. The device according to claim 8, further comprising an optical media whose optical state changes in response to a change in electrical potential at one or more of the pixel conductors.

10. The device according to claim 1, further comprising an array of pixel conductors each associated with a respective one of said array of transistors, and each row of transistors comprises the transistors for a respective row of pixel electrodes, and each column of transistors comprises the transistors for a respective column of pixel electrodes.
